(19) United States
(12) Patent Application Publication
(10) Pub. No.: US 2015/0130843 A1
(43) Pub. Date: May 14, 2015

(54) LENS VIEW FOR MAP

(71) Applicant: Microsoft Corporation, Redmond, WA (US)

(72) Inventors: Roberto Javier Bojorquez Alfaro, Bothell, WA (US); Doyop Kim, Emeryville, CA (US); Hae Jin Lee, Seattle, WA (US); Haider Ali Razvi, Sunnyvale, CA (US); Raymond William Rischpater, Boulder Creek, CA (US)

(73) Assignee: Microsoft Corporation, Redmond, WA (US)

(21) Appl. No.: 14/079,958

(22) Filed: Nov. 14, 2013

(51) Int. Cl. G06T 3/60; G06T 3/40

(52) U.S. Cl. CPC G06T 3/60; G06T 3/40
USPC 345/650

(57) ABSTRACT

One or more techniques and/or systems are provided for providing a lens view associated with a map canvas. The map canvas may depict an area comprising one or more locations associated with imagery of such locations (e.g., a map of a shopping district may comprise a toy store associated with imagery of the toy store). Accordingly, the map canvas may be populated with a lens view depicting a location within the map canvas (e.g., depicting imagery of the toy store). A correspondence between a lens heading of the lens view and a map heading of the map canvas may be maintained. For example, responsive to rotation of the map canvas changing a current map heading of the map canvas to a rotated map heading, a current lens heading of the lens view maybe modified to a rotated lens heading corresponding to the rotated map heading.

### BACKGROUND

Many applications and/or websites provide information through maps. For example, a videogame may display a destination for a user on a map; a running website may display running routes through a web map interface; a mobile map app may display driving directions on a road map; a realtor app may display housing information, such as images, sale prices, home value estimates, and/or other information on a map; etc. Such applications and/or websites may facilitate various types of user interactions with maps. In an example, a user may zoom-in, zoom-out, and/or rotate a viewing angle of a map. In another example, the user may mark locations within a map using pinpoint markers (e.g., create a running route using pinpoint markers along the route). In this way, users may view various information and/or perform various tasks through maps.

### SUMMARY

This summary is provided to introduce a selection of concepts in a simplified form that are further described below in the detailed description. This summary is not intended to identify key factors or essential features of the claimed subject matter, nor is it intended to be used to limit the scope of the claimed subject matter.

Among other things, one or more systems and/or techniques for providing a lens view associated with a map canvas are provided. A user interface (e.g., an app such as a realtor app, a website such as a driving directions website, a GPS map device, etc.) may display a map canvas at a first scale. For example, the map canvas may display a shopping district of a city. The map canvas may be populated with a lens view depicting a location, associated with the map canvas, at a second scale having a higher level of granularity than the first scale. For example, the lens view may depict imagery of a department store building within the shopping district (e.g., photos depicting the department store at a street-level view, such as a view that is normal to a horizon of the shopping district). Rotation of the map canvas may change the map canvas from a current map heading to a rotated map heading (e.g., programmatic input, such as by an application, panorama functionality, or other functionality, may rotate the map canvas; user input, such as a touch gesture, a mouse or keyboard input, and/or movement of a device captured by a gyroscope, compass, and/or other sensor may rotate the map canvas; etc.). Accordingly, a current leans heading of the lens view may be modified to a rotated lens heading corresponding to the rotated map heading. For example, responsive to a user rotating the map canvas in a clockwise direction, the lens view may be rotated in a clockwise direction (e.g., to maintain a one-to-one correspondence between a map heading and a lens heading). In an example, responsive to rotation of the lens view, the lens view and/or the map canvas may be rotated based upon the lens view rotation. In an example, a lens pitch of the lens view may be maintained (e.g., unmodified) when a map pitch of the map canvas is changed.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a flow diagram illustrating an exemplary method of providing a lens view associated with a map canvas.

FIG. 2 is an illustration of an example of a map canvas.

FIG. 3A is a component block diagram illustrating an exemplary system for providing a lens view associated with a map canvas.

FIG. 3B is a component block diagram illustrating an exemplary system for modifying a lens heading of a lens view based upon a map heading of a map canvas.

FIG. 3C is a component block diagram illustrating an exemplary system for modifying a map heading of a map canvas based upon a lens heading of a lens view.

FIG. 3D is a component block diagram illustrating an exemplary system for maintaining a lens pitch of a lens view notwithstanding a change in map pitch for a map canvas.

FIG. 4 is a component block diagram illustrating an exemplary system for displaying a lens view.

FIG. 5A is a component block diagram illustrating an exemplary system for displaying a lens view.

FIG. 5B is a component block diagram illustrating an exemplary system for displaying an interactive street-level depiction of a location within a map canvas.

FIG. 5C is a component block diagram illustrating an exemplary system for displaying an interactive street-level depiction of a location within a map canvas.

FIG. 6 is a component block diagram illustrating an exemplary system for displaying a lens view.

FIG. 7 is an illustration of an exemplary computer readable medium wherein processor-executable instructions configured to embody one or more of the provisions set forth herein may be comprised.

FIG. 8 illustrates an exemplary computing environment wherein one or more of the provisions set forth herein may be implemented.

### DETAILED DESCRIPTION

The claimed subject matter is now described with reference to the drawings, wherein like reference numerals are generally used to refer to like elements throughout. In the following description, for purposes of explanation, numerous specific details are set forth in order to provide an understanding of the claimed subject matter. It may be evident, however, that the claimed subject matter may be practiced without these specific details. In other instances, structures and devices are illustrated in block diagram form in order to facilitate describing the claimed subject matter.

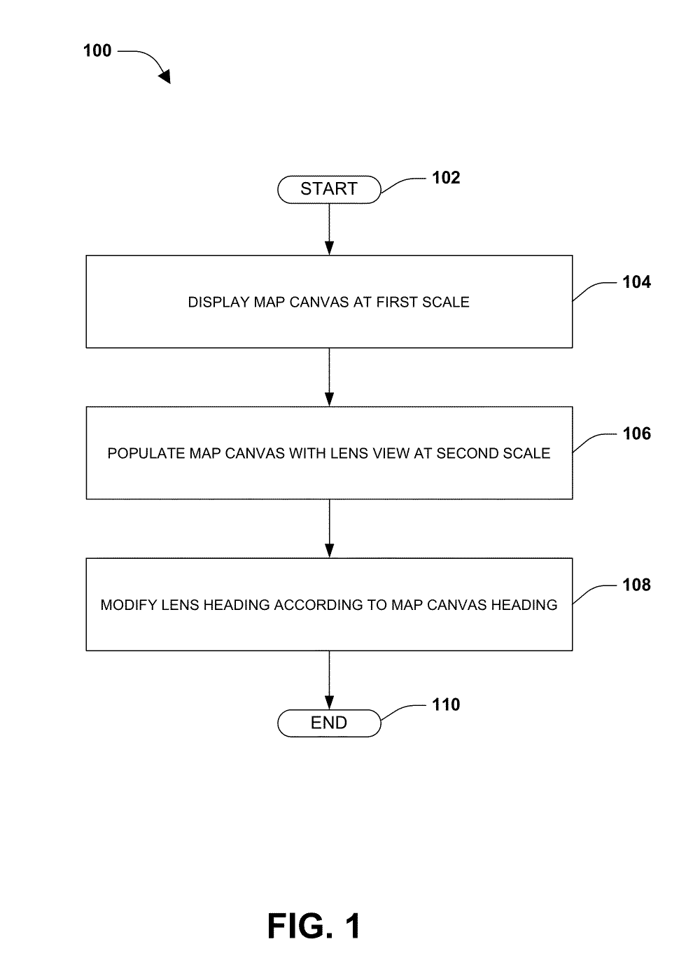

An embodiment of providing a lens view associated with a map canvas is illustrated by an exemplary method 100 of FIG. 1. At 102, the method starts. At 104, a map canvas may be displayed at a first scale. For example, the map canvas may depict a few square miles of a college campus. In an example, imagery, such as photos, may be available for one or more locations within the map canvas (e.g., a student may have shared photos of a student union building through a social network or microblog message).

At 106, the map canvas may be populated with a lens view depicting a location, associated with the map canvas, at a second scale having a higher level of granularity than the first scale. In an example, the lens view may be populated within the map canvas based upon a touch gesture associated with the map canvas (e.g., a user may ‘touch’ the location on the map, the user may select an interface element representing the location, etc.). In an example, the lens view may depict imagery of the location (e.g., a panorama view of the student union building stitched together using the photos shared by the user). In an example, the lens view may depict the location according to a street-level view, such as a view that is normal to a horizon of the location or a view having a lens pitch between about −15° and about +15°. In an example, the lens view may be displayed within the map canvas (e.g., as a user interface element within the map canvas). In another example, the map canvas may be displayed within a map interface, and the lens view may be displayed within an interface not comprised within the map interface (e.g., a side-bar interface; an interface that is adjacent to the map interface; a pop-up/floating interface; etc.).

The lens view may be anchored to the location within the map canvas utilizing a stem. For example, the stem may anchor the lens view based upon a longitude value and/or a latitude value. Responsive to a change in position of the map canvas (e.g., rotational movement, panning movement, pitch movement, etc.), the stem may be utilized to anchor the lens view to the location within the map canvas. Response to determining that the map canvas is displayed according to a nadir view (e.g., a top-down view along a plumb line), the stem may be displayed at a position relative to the lens view and the location within the map canvas (e.g., the stem may be displayed along an edge of the lens view at a position corresponding the location). In an example, responsive to determining that a lens position of the lens view corresponds to a map entity position of an entity within the map canvas (e.g., a 3D structure, such as a building), the lens view may be displayed over the entity (e.g., a z-position of the lens view (e.g., perpendicular to the plane within which the map canvas lies) may be specified such that the lens view overlays the map canvas and/or entities populated therein).

At 108, responsive to rotation of the map canvas changing a current map heading of the map canvas to a rotated map heading (e.g., a heading corresponding to points of a compass), modifying a current lens heading of the lens view to a rotated lens heading corresponding to the rotated map heading. For example, responsive to a user rotating the map canvas in a clockwise direction (e.g., from a North heading to a Northeast heading), the lens view may be rotated in a clockwise direction (e.g., such as from a North heading to a Northeast heading in order to maintain a one-to-one correspondence between a map heading and a lens heading). In an example, responsive to identifying rotational input associated with the lens view, the lens view and the map canvas may be rotated based upon the rotational input. Rotational input for the map canvas and/or the lens view may be detected based upon touch input, application programmatic input (e.g., an animation, panorama functionality, an application, a web service, an app, a code module, an operating system, a videogame, etc.), gyroscopic input, compass input, and/or user input. In contrast to maintaining a correspondence between the map heading and the lens heading, a lens pitch of the lens view may be maintained notwithstanding a change in map pitch for the map canvas. For example, responsive to identifying a change in map pitch for the map canvas, the lens pitch of the lens view may be refrained from being modified. In an example, responsive to receiving input associated with the lens view, the map canvas may be transitioned to an interactive street-level depiction of the location (e.g., an interactive panorama view of the student union building). At 110, the method ends.

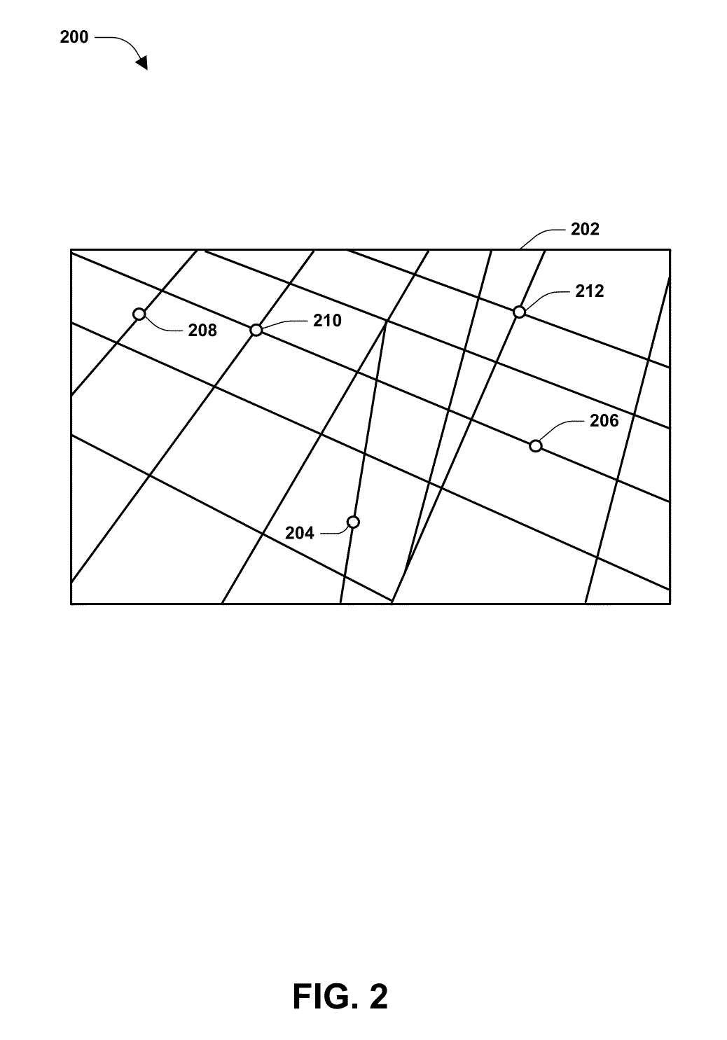

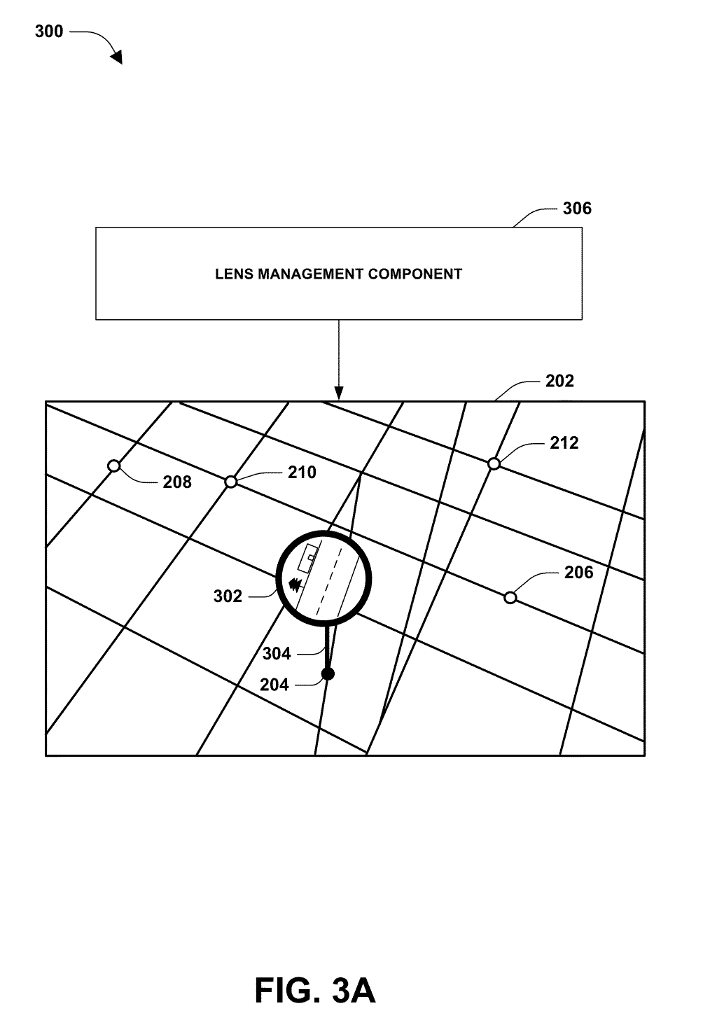

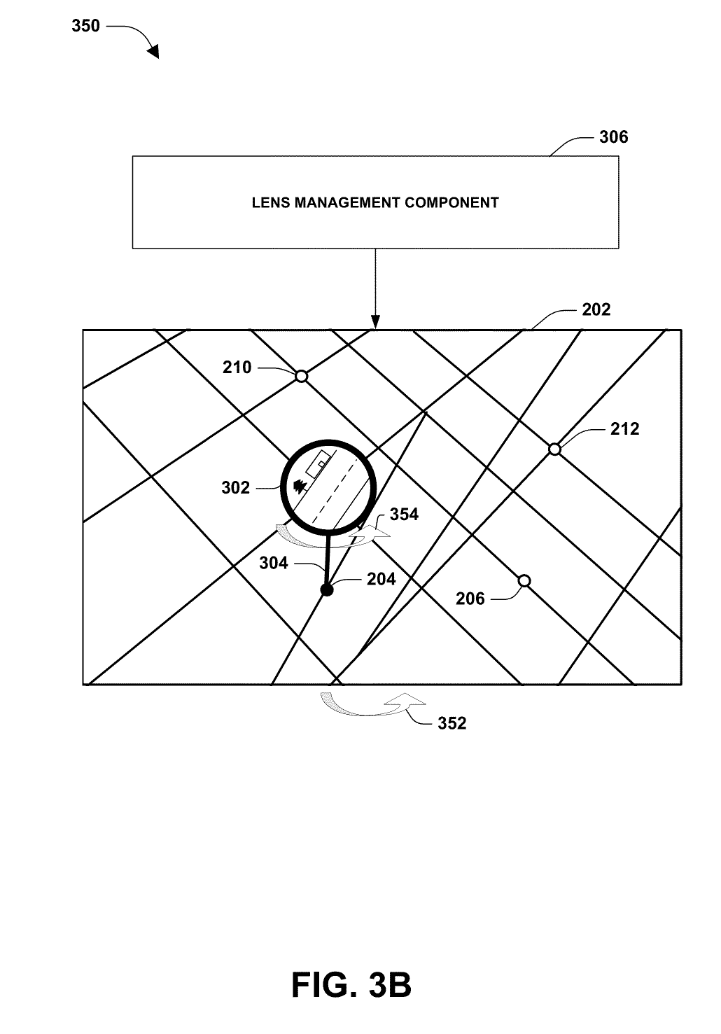

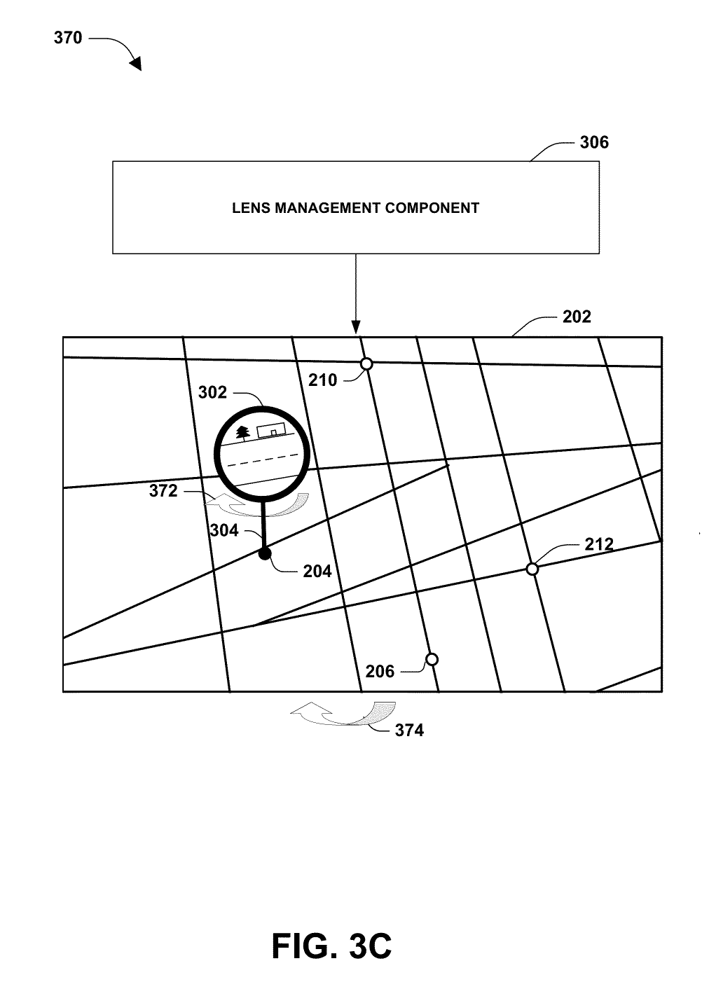

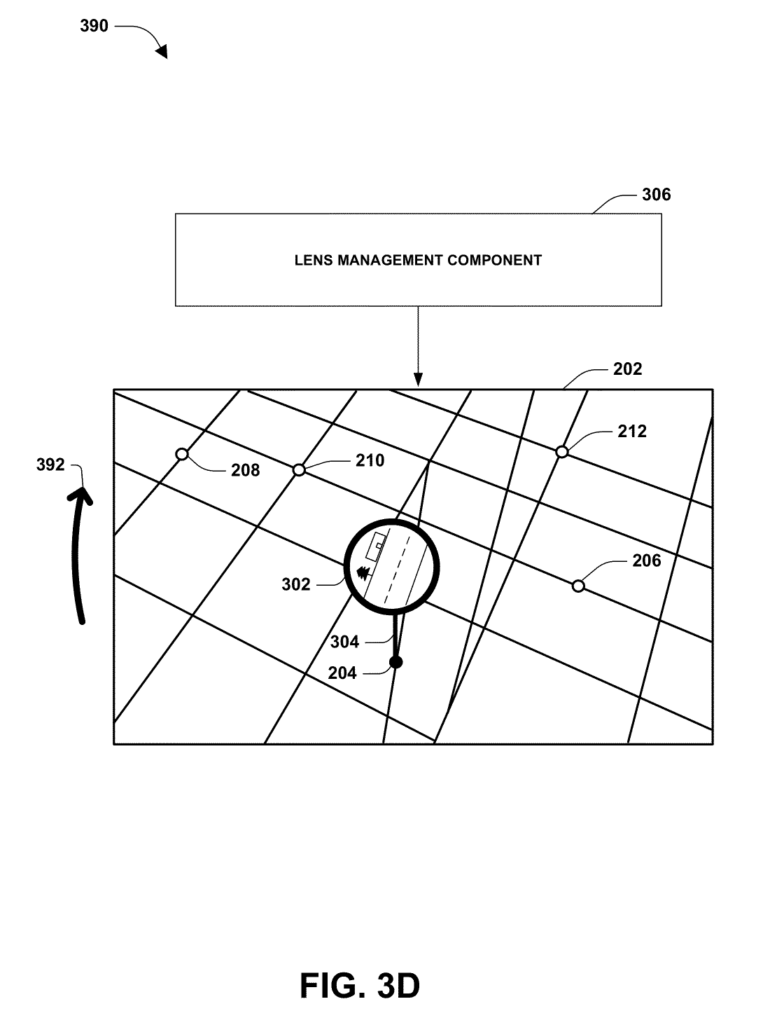

FIG. 2 illustrates an example 200 of a map canvas 202. The map canvas 202 may be provided by a website (e.g., a mapping website), a web service, a cloud service, a mobile app (e.g., a realtor app, a running app, a map app, etc.), an application, a GPS device, a videogame console (e.g., a map provided by a video game), and/or through any other computing device. Locations within the map canvas 202 may be associated with imagery depicting such locations. For example, the map canvas 202 may depict a shopping district of a city having a first location 204, a second location 206, a third location 208, a fourth location 210, and a fifth location 212 associated with imagery depicting such locations. Responsive to selection of a location, a lens view depicting the location (e.g., displaying the imagery, a panorama derived from the imagery, and/or other view of the location) may be populated within the map canvas 202 (e.g., FIG. 3A).

FIG. 3A illustrates an example of a system 300 for providing a lens view 302 associated with a map canvas 202. The system 300 may comprise a lens management component 306 associated with the map canvas 202. The map canvas 202 may depict a shopping district of a city having a first location 204, a second location 206, a third location 208, a fourth location 210, and a fifth location 212 associated with imagery depicting such locations. Responsive to selection of the first location 204, the lens management component 306 may be configured to populate the map canvas 202 with the lens view 302. The lens view 302 may be anchored to the first location 204 by a stem 304. The stem 304 may be used to anchor the lens view 302 to the first location 204 notwithstanding a change in position of the map canvas 202 (e.g., a panning movement, rotational movement, a change in pitch, zooming in or out, etc.). The lens view 302 may depict a videogame store (e.g., based upon imagery of the videogame store) at the first location 204 within the shopping district. The lens view 302 may depict the videogame store according to a street-level view that is normal to a horizon of the first location 204 (e.g., the street-level view may have a lens pitch between about −15° and about +15°). The map canvas 202 may depict the shopping district according to a first scale, and the lens view 302 may depict the videogame store according to a second scale having a higher level of granularity than the first scale. In this way, a user may view details of the videogame store at a higher level of detail through the lens view 302 without having to change a scale of the map canvas 202.

FIG. 3B illustrates an example of a system 350 for modifying a lens heading of a lens view 302 based upon a map heading of a map canvas 202. The system 350 may comprise a lens management component 306 associated with the map canvas 202. In an example, the lens management component 306 may have populated the map canvas 202 with the lens view 302 depicting a first location 204, such as a videogame store, within the map canvas 202 (e.g., FIG. 3A). The lens management component 306 may be configured to detect a rotation 352 of the map canvas 202 that changes a current map heading of the map canvas 202 to a rotated map heading (e.g., based upon user touch input, user mouse input, etc.). Accordingly, the lens management component 306 may be configured to modify 354 a current lens heading of the lens view 302 to a rotated lens heading corresponding to the rotated map heading. In this way, a correspondence between the lens heading and the canvas heading may be maintained.

FIG. 3C illustrates an example of a system 370 for modifying a map heading of a map canvas 202 based upon a lens heading of a lens view 302. The system 370 may comprise a lens management component 306 associated with the map canvas 202. In an example, the lens management component 306 may have populated the map canvas 202 with the lens view 302 depicting a first location 204, such as a videogame store, within the map canvas 202 (e.g., FIG. 3A). The lens management component 306 may be configured to detect a rotation 372 of the lens view 302 (e.g., based upon user touch input, user mouse input, etc.). The lens management component 306 may rotate the lens view 302 (e.g., modifying the lens heading of the lens view 302) and/or may rotate 374 the map canvas (e.g., modifying the map heading of the map canvas 202) based upon the rotational input 372. In this way, a correspondence between the lens heading and the canvas heading may be maintained.

FIG. 3D illustrates an example of a system 390 for maintaining a lens pitch of a lens view 302 notwithstanding a change in map pitch for a map canvas 202. The system 390 may comprise a lens management component 306 associated with the map canvas 202. In an example, the lens management component 306 may have populated the map canvas 202 with the lens view 302 depicting a first location 204, such as a videogame store, within the map canvas 202 (e.g., FIG. 3A). The lens management component 306 may be configured to detect a change 392 in map pitch for the map canvas 202. Responsive to the change 392 in map pitch, the lens management component 306 may refrain from modifying the lens pitch of the lens view 302. In this way, the lens pitch of the lens view 302 is maintained notwithstanding the change in map pitch for the map canvas 202. In an example, imagery of the video game store displayed through the lens view 302 remains substantially static (e.g., such that a user may continue to view, browse, etc. video games through the lens view 302) despite a change in pitch of the map canvas 202.

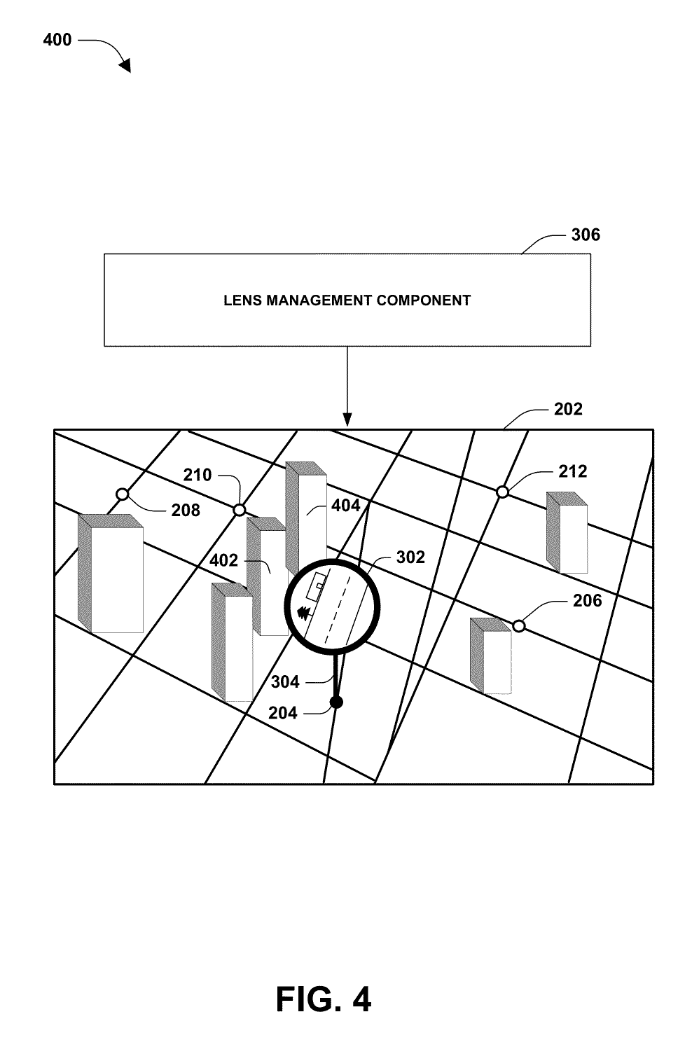

FIG. 4 illustrates an example of a system 400 for displaying a lens view 302. The system 400 may comprise a lens management component 306 associated with the map canvas 202. In an example, the lens management component 306 may have populated the map canvas 202 with the lens view 302 depicting a first location 204, such as a videogame store, within the map canvas 202 (e.g., FIG. 3A). In an example, the map canvas 202 may be populated with one or more entities, such as a first 3D building entity 402 and a second 3D building entity 404. The lens management component 306 may be configured to display the lens view 302 over the first 3D building entity 402, the second 3D building entity 404, and/or other entities. For example, the lens management component 306 may set a z-position for the lens view 302 to a value greater than or equal to a z-position of the first 3D building entity 402, the second 3D building entity 404, and/or other entities so that the lens view 302 is not obscured by the 3D or other entities on the map canvas 202.

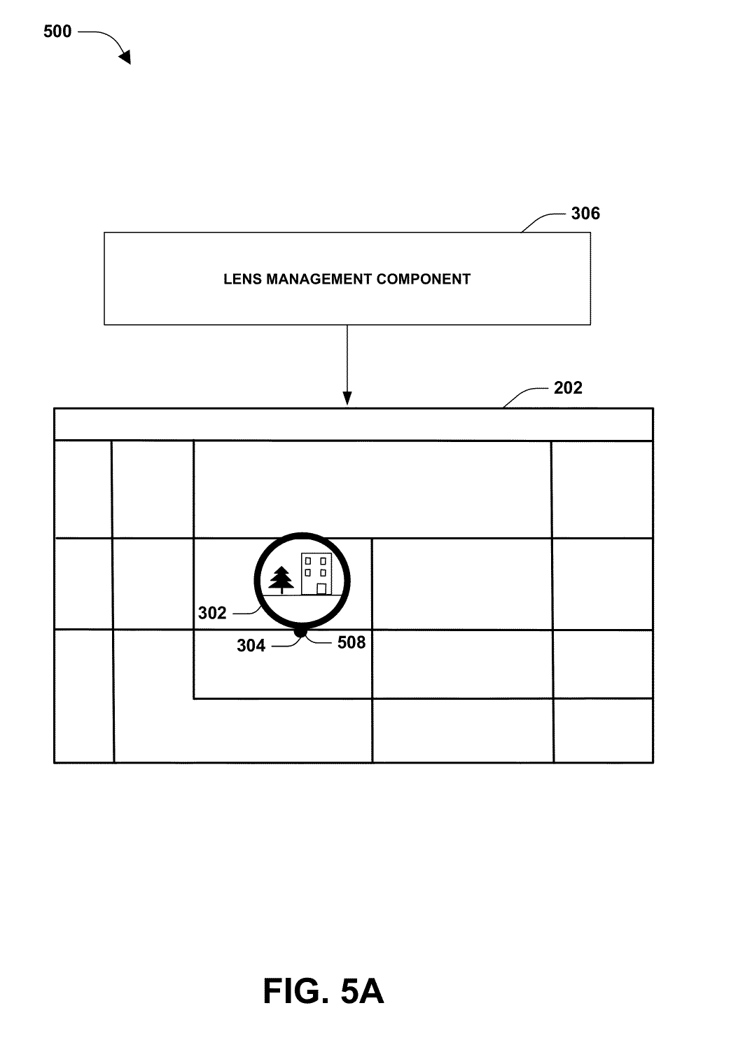

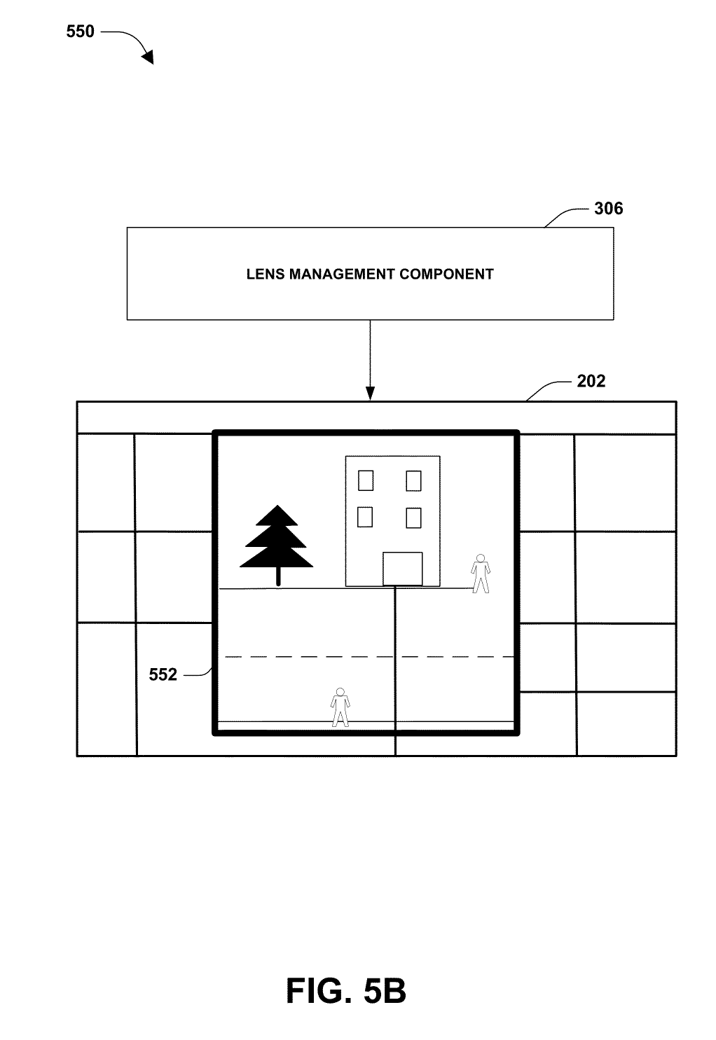

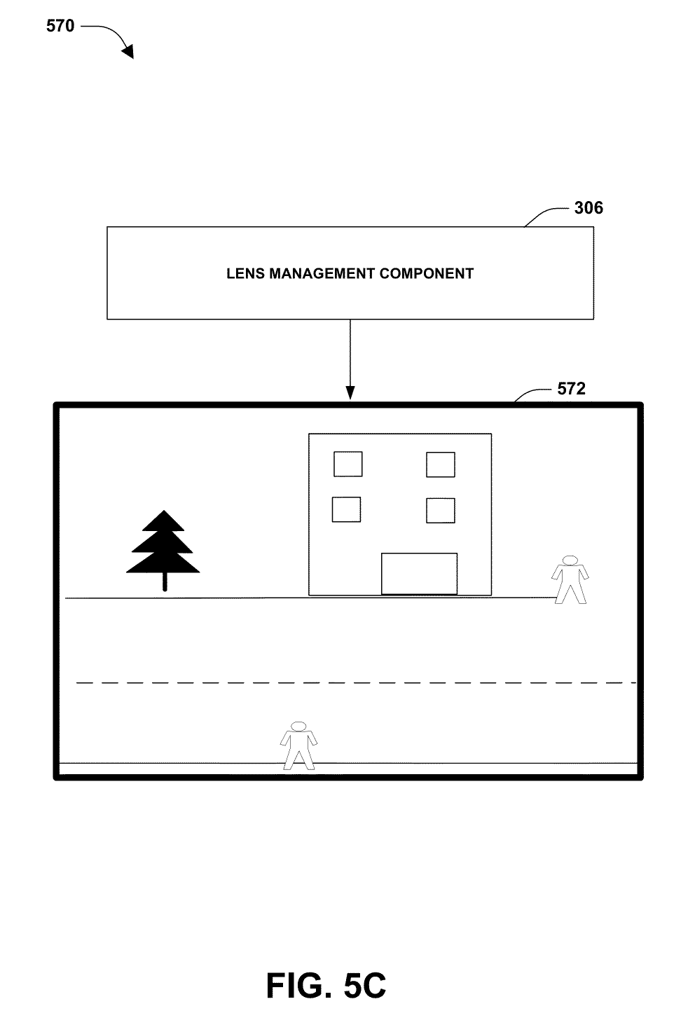

FIG. 5A illustrates an example of a system 500 for displaying a lens view 302. The system 500 may comprise a lens management component 306 associated with the map canvas 202. In an example, the lens management component 306 may have populated the map canvas 202 with the lens view 302 depicting a location 508, such as an office building in a downtown portion of a city, within the map canvas 202. In an example, the map canvas 202 may be displayed according to a nadir view (e.g., a top-down view along a plumb line that is substantially perpendicular to a plane within which the map canvas 502 lies). The lens management component 306 may anchor the lens view 302 to the location 508 using a stem 304. The stem 304 may be used for anchoring the lens view and/or may be displayed notwithstanding the map canvas 202 being displayed according to the nadir view. For example, the stem 304 may be displayed along an edge of the lens view 302 at a position between the lens view 302 and the location 508.

FIG. 5B illustrates an example of a system 550 for displaying an interactive street-level depiction 552 of a location 508 within a map canvas 202. The system 500 may comprise a lens management component 306 associated with the map canvas 202. In an example, the lens management component 306 may have populated the map canvas 202 with a lens view 302 depicting the location 508, such as an office building, within the map canvas 202 (e.g., FIG. 5A). The lens management component 306 may receive input associated with the lens view 302 (e.g., user input such as a selection of the lens view 302; application programmatic input used to invoke a selection method/function for the lens view 302; etc.). Accordingly, the lens management component 306 may transition the map canvas 202 to the interactive street-level depiction 552 of the location 504 based upon the input (e.g., the interactive street-level depiction 552 may be displayed within an interactive user interface within the map canvas 202). For example, a user may navigate around the location 508 by interacting with the interactive street-level depiction 552 (e.g., tilt, rotate, pan, zoom, entity selection, product purchase, endorse, like, comment, review, and/or other interaction may be facilitated through the interactive street-level depiction 552).

FIG. 5C illustrates an example of a system 570 for displaying an interactive street-level depiction 572 of a location 508 within a map canvas 202. The system 500 may comprise a lens management component 306 associated with the map canvas 202. In an example, the lens management component 306 may have populated the map canvas 202 with a lens view 302 depicting the location 508, such as an office building, within the map canvas 202 (e.g., FIG. 5A). The lens management component 306 may receive input associated with the lens view 302 (e.g., user input such as a selection of the lens view 302; application programmatic input used to invoke a selection method/function for the lens view 302; etc.). Accordingly, the lens management component 306 may transition the map canvas 202 to the interactive street-level depiction 572 of the location 508 (e.g., the interactive street-level depiction 572 may be displayed within an interactive user interface that may replace the map canvas 202). For example, a user may navigate around the location 508 by interacting with the interactive street-level depiction 572 (e.g., tilt, rotate, pan, zoom, entity selection, product purchase, endorse, like, comment, review and/or other interaction may be facilitated through the interactive street-level depiction 572).

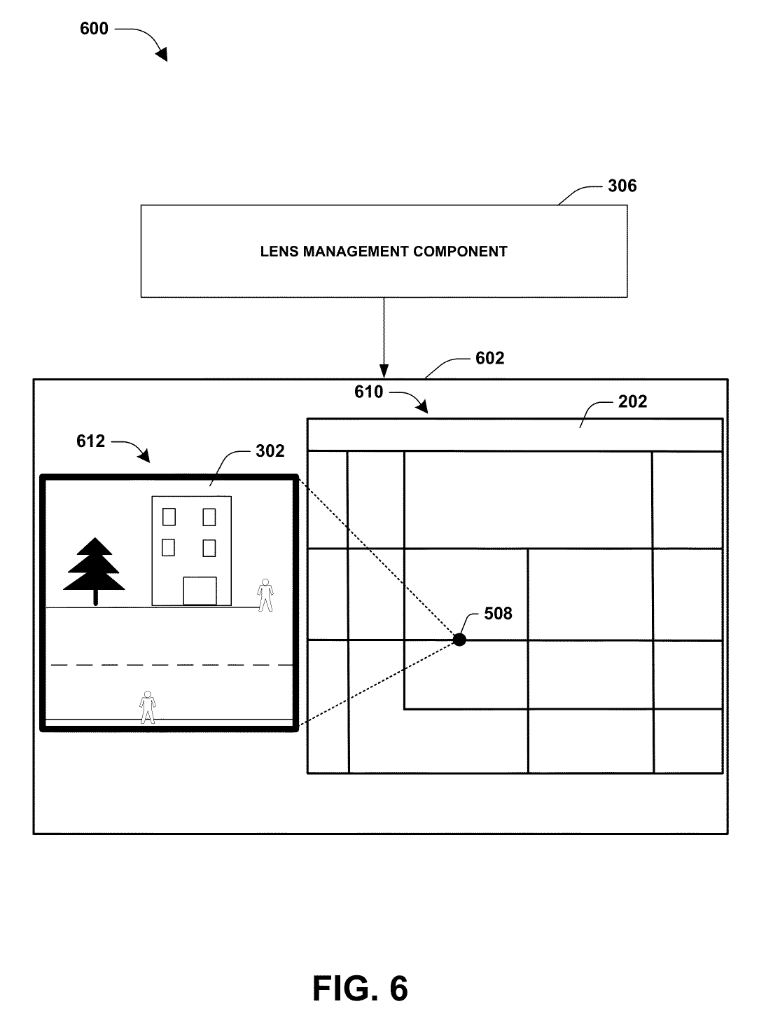

FIG. 6 illustrates an example of a system 600 for displaying a lens view 302. The system 600 may comprise a lens management component 306 associated with a user interface 602. The user interface 602 may depict a map canvas 202 comprising a location 508. The map canvas 202 may be displayed through a map interface 610. Responsive to a selection of the location 508, the lens management component 306 may display the lens view 302 within an interface 612. In an example, the interface 612 is not comprised within the map interface 610. In an example, the interface 612 is displayed adjacent to the map interface 610, such as within a side bar interface.

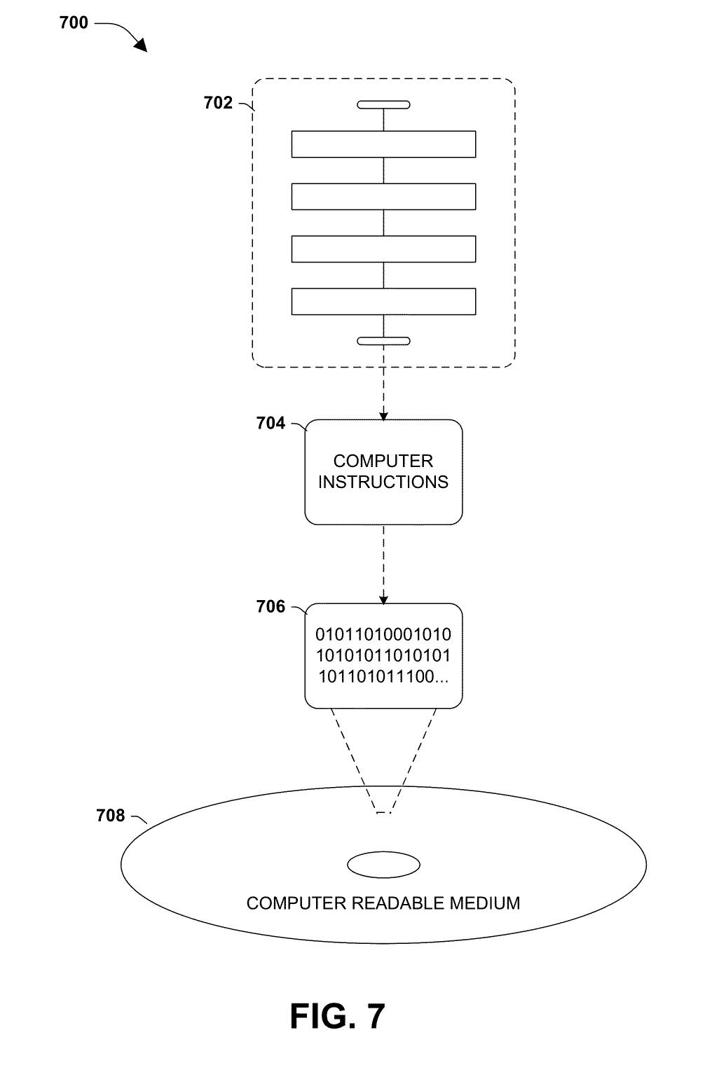

Still another embodiment involves a computer-readable medium comprising processor-executable instructions configured to implement one or more of the techniques presented herein. An example embodiment of a computer-readable medium or a computer-readable device is illustrated in FIG. 7, wherein the implementation 700 comprises a computer-readable medium 708, such as a CD-R, DVD-R, flash drive, a platter of a hard disk drive, etc., on which is encoded computer-readable data 706. This computer-readable data 706, such as binary data comprising at least one of a zero or a one, in turn comprises a set of computer instructions 704 configured to operate according to one or more of the principles set forth herein. In some embodiments, the processor-executable computer instructions 704 are configured to perform a method 702, such as at least some of the exemplary method 100 of FIG. 1, for example. In some embodiments, the processor-executable instructions 704 are configured to implement a system, such as at least some of the exemplary system 300 of FIG. 3A, at least some of the exemplary system 350 of FIG. 3B, at least some of the exemplary system 370 of FIG. 3C, at least some of the exemplary system 390 of FIG. 3D, at least some of the exemplary system 400 of FIG. 4, at least some of the exemplary system 500 of FIG. 5A, at least some of the exemplary system 550 of FIG. 5B, at least some of the exemplary system 570 of FIG. 5C, and/or at least some of the exemplary system 600 of FIG. 6, for example. Many such computer-readable media are devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

As used in this application, the terms “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

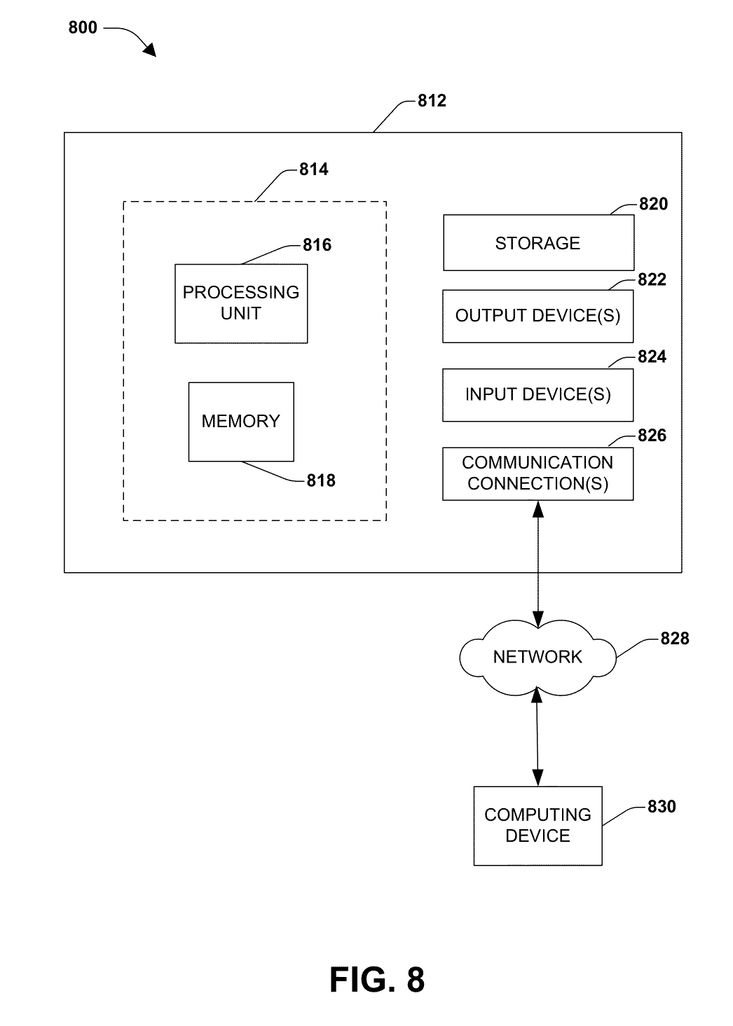

FIG. 8 and the following discussion provide a brief, general description of a suitable computing environment to implement embodiments of one or more of the provisions set forth herein. The operating environment of FIG. 8 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 8 illustrates an example of a system 800 comprising a computing device 812 configured to implement one or more embodiments provided herein. In one configuration, computing device 812 includes at least one processing unit 816 and memory 818. Depending on the exact configuration and type of computing device, memory 818 may be volatile (such as RAM, for example), non-volatile (such as ROM, flash memory, etc., for example) or some combination of the two. This configuration is illustrated in FIG. 8 by dashed line 814.

In other embodiments, device 812 may include additional features and/or functionality. For example, device 812 may also include additional storage (e.g., removable and/or non-removable) including, but not limited to, magnetic storage, optical storage, and the like. Such additional storage is illustrated in FIG. 8 by storage 820. In one embodiment, computer readable instructions to implement one or more embodiments provided herein may be in storage 820. Storage 820 may also store other computer readable instructions to implement an operating system, an application program, and the like. Computer readable instructions may be loaded in memory 818 for execution by processing unit 816, for example.

The term “computer readable media” as used herein includes computer storage media. Computer storage media includes volatile and nonvolatile, removable and non-removable media implemented in any method or technology for storage of information such as computer readable instructions or other data. Memory 818 and storage 820 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 812. Any such computer storage media may be part of device 812.

Device 812 may also include communication connection(s) 826 that allows device 812 to communicate with other devices. Communication connection(s) 826 may include, but is not limited to, a modem, a Network Interface Card (NIC), an integrated network interface, a radio frequency transmitter/receiver, an infrared port, a USB connection, or other interfaces for connecting computing device 812 to other computing devices. Communication connection(s) 826 may include a wired connection or a wireless connection. Communication connection(s) 826 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 812 may include input device(s) 824 such as keyboard, mouse, pen, voice input device, touch input device, infrared cameras, video input devices, and/or any other input device. Output device(s) 822 such as one or more displays, speakers, printers, and/or any other output device may also be included in device 812. Input device(s) 824 and output device(s) 822 may be connected to device 812 via a wired connection, wireless connection, or any combination thereof. In one embodiment, an input device or an output device from another computing device may be used as input device(s) 824 or output device(s) 822 for computing device 812.

Components of computing device 812 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 812 may be interconnected by a network. For example, memory 818 may be comprised of multiple physical memory units located in different physical locations interconnected by a network.

Those skilled in the art will realize that storage devices utilized to store computer readable instructions may be distributed across a network. For example, a computing device 830 accessible via a network 828 may store computer readable instructions to implement one or more embodiments provided herein. Computing device 812 may access computing device 830 and download a part or all of the computer readable instructions for execution. Alternatively, computing device 812 may download pieces of the computer readable instructions, as needed, or some instructions may be executed at computing device 812 and some at computing device 830.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein. Also, it will be understood that not all operations are necessary in some embodiments.

Further, unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “exemplary” is used herein to mean serving as an example, instance, illustration, etc., and not necessarily as advantageous. As used herein, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B or both A and B. Furthermore, to the extent that “includes”, “having”, “has”, “with”, and/or variants thereof are used in either the detailed description or the claims, such terms are intended to be inclusive in a manner similar to the term “comprising”.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A method for providing a lens view associated with a map canvas, comprising:
displaying a map canvas at a first scale;
populating the map canvas with a lens view depicting a location, associated with the map canvas, at a second scale having a higher level of granularity than the first scale; and
responsive to rotation of the map canvas changing a current map heading of the map canvas to a rotated map heading, modifying a current lens heading of the lens view to a rotated lens heading corresponding to the rotated map heading.

2. The method of claim 1, the lens view depicting imagery of the location.

3. The method of claim 1, the lens view the depicting the location according to a street-level view.

4. The method of claim 3, the street-level view normal to a horizon of the location.

5. The method of claim 3, the street-level view having a lens pitch between −15° to +15°.

6. The method of claim 1, comprising:
responsive to identifying a change in map pitch for the map canvas, refraining from modifying a lens pitch of the lens view.

7. The method of claim 1, comprising:
responsive to determining that a lens position of the lens view corresponds to a map entity position of an entity within the map canvas, displaying the lens view over the entity.

8. The method of claim 7, the entity comprising a 3D structure within the map canvas.

9. The method of claim 1, comprising:
anchoring the lens view to the location within the map canvas utilizing a stem.

10. The method of claim 9, comprising:
responsive to identifying a change in position of the map canvas, utilizing the stem to anchor the lens view to the location within the map canvas.

11. The method of claim 9, the anchoring comprising utilizing the stem to anchor the lens view based upon at least one of a longitude value or a latitude value.

12. The method of claim 9, comprising:
responsive to determining that the map canvas is displayed according to a nadir view, displaying the stem at a position relative to the lens view and the location within the map canvas.

13. The method of claim 1, comprising:
responsive to receiving input associated with the lens view, transitioning the map canvas to an interactive street-level depiction of the location.

14. The method of claim 1, comprising:
responsive to identifying rotational input associating with the lens view, rotating the lens view and the map canvas based upon the rotational input.

15. The method of claim 1, comprising:
detecting rotational input used to rotate the map canvas based upon at least one of touch input, application programmatic input, gyroscopic input, compass input, or user input; and
the modifying comprising modifying the current lens heading based upon the rotational input.

16. The method of claim 1, the populating the map canvas comprising:
displaying the lens view within the map canvas responsive to a touch gesture associated with the map canvas.

17. The method of claim 1, the map canvas displayed within a map interface, and the populating the map canvas comprising:
displaying the lens view within an interface not comprised within the map interface.

18. A system for providing a lens view through a map canvas, comprising:
a lens management component configured to:
display a map canvas at a first scale;
populate the map canvas with a lens view depicting a location on the map canvas at a second scale having a higher level of granularity than the first scale; and
responsive to rotation of the map canvas changing a current map heading of the map canvas to a rotated map heading, modify a current lens heading of the lens view to a rotated lens heading corresponding to the rotated map heading.

19. The system of claim 18, the lens management component configured to:
responsive to identifying a change in map pitch for the map canvas, refrain from modifying a lens pitch of the lens view.

20. A computer readable medium comprising instructions which when executed at least in part via a processing unit perform a method for providing a lens view through a map canvas, comprising:
displaying a map canvas at a first scale;
populating the map canvas with a lens view depicting a location on the map canvas at a second scale having a higher level of granularity than the first scale; and
responsive to rotation of the map canvas changing a current map heading of the map canvas to a rotated map heading, modifying a current lens heading of the lens view to a rotated lens heading corresponding to the rotated map heading.
